(19) United States
(12) Patent Application Publication
(10) Pub. No.: US 2024/0283187 A1
(43) Pub. Date: Aug. 22, 2024

(54) INTEGRATED TERMINAL POSITION ASSURANCE AND CORRESPONDING ELECTRIC CONNECTOR

(71) Applicant: APTIV ELECTRICAL CENTERS (SHANGHAI) CO. LTD., Shanghai (CN)

(72) Inventors: Dongdong LI, Shanghai (CN); Suibin HUANG, Shanghai (CN); Zhaofei MA, Shanghai (CN); Vinu ARUMUGAM, Chennai (IN)

(21) Appl. No.: 18/443,644

(22) Filed: Feb. 16, 2024

(30) Foreign Application Priority Data
Feb. 17, 2023 (CN) 202310134928.8
May 5, 2023 (CN) 202310498882.8

(51) Int. Cl. H01R 13/436; H01R 13/639

(52) U.S. Cl. CPC H01R 13/4362; H01R 13/639

(57) ABSTRACT

The disclosure provides an integrated terminal position assurance device and a corresponding electric connector. An electric connector according to the present patent application includes: a first connector housing, including a plurality of first terminal channels; and a terminal position assurance device including one or more terminal position assurance (TPA) components, wherein each TPA component includes a male terminal lock structure on one side and a female terminal lock structure on another side, the terminal position assurance device being capable of being installed in a terminal position assurance cavity of the first connector housing.

### CROSS-REFERENCE TO RELATED APPLICATION

This application claims benefit of priority to Chinese Patent Application No. 202310498882.8 filed on May 5, 2023, and further claims benefit of priority to Chinese Patent Application No. 202310134928.8 filed on Feb. 17, 2023, the entire disclosure of each of which is hereby incorporated by reference.

### TECHNICAL FIELD OF THE INVENTION

The present disclosure relates to electrical connection technology, and in particular to an integrated terminal position assurance device supporting both male end locking and female end locking, such integrated terminal position assurance device being capable of being installed into a first connector housing, and when the first connector housing and another mating connector housing are mated in place, being capable of simultaneously acting as a terminal position assurance device for the terminals in both connector housings.

### BACKGROUND

The on-board electronics of modern automobiles rely on the automotive electronic and electrical architecture (EEA) to realize the transmission of data signals and electrical energy. An EEA system typically consists of wire harness products which include various connectors.

Electric connector products used in the wire harness products typically include a male connector and a female connector that are to be used in pair, the male connector, and the female connector each includes an insulated outer plastic housing, and, according to the design requirements, may or may not include an insulated inner housing. Metal terminals for electrical conduction are mounted and positioned in the male and female connectors. When a male connector and a female connector are connected together, the terminals contained in each are also connected together to establish an electrical connection between them.

Typically, unless otherwise indicated, a female connector refers to a connector loaded with female terminals in the form of, for example, a cable end plug connector, and a male connector refers to a connector loaded with male terminals in the form of, for example, a socket connector, or another cable end plug connector.

FIGS. 1A and 1B show an inner housing 100 in a commercially delivered male electrical connector, wherein FIG. 1A shows the mating end of the inner housing 100 and FIG. 1B shows the cable inlet tail of the inner housing 100. As shown in FIGS. 1A and 1B, the inner housing 100 is an insulating housing that includes a plurality of terminal channels, each of which may have a terminal mounted therein accordingly.

After these terminals are mounted in place as described above, it is often necessary to take further steps to enhance the stability of the terminals. One approach to enhance terminal stability is to use a device called Terminal Position Assurance (TPA). FIG. 1A illustrates the spatial dimension relationship of three unloaded TPA devices 120 and the inner housing 100, and FIG. 1C shows a perspective view of a single TPA device 120. As shown in FIG. 1C, the TPA device 120 includes a base plate 121, baffles 122 and 123 vertically extending from both sides of the base plate 121, and also a latching plate 124 extending therefrom that is perpendicular to and connected to the two baffles. A latching beam 125 is provided at the top of the latching plate 124. As shown in FIG. 1A, the three TPA devices 120 are to be loaded from the mating end of the inner housing 100 (i.e., an end opposite to the cable inlet tail shown in FIG. 1B).

FIG. 1D shows a cross-sectional view of a male connector 10 consisting of an inner housing 110 and a corresponding outer housing 130. As shown in FIG. 1D, the inner housing 110 is provided with terminal channels 114 at both the upper potion and lower portion thereof, and the TPA device 120 is mounted in a TPA containing cavity 115 which is in the middle of the inner housing 100 and between the terminal channels, wherein the latching beam 125 of the TPA device 120 and the latching protrusion 1151 on the inner wall of the TPA containing cavity 115 form a latching and positioning relationship to prevent accidental withdrawal of the TPA device 120. A part of the sidewall 1142 (the upper and lower sidewalls in FIG. 1D) of the TPA containing cavity 115 form a locking wall of the terminal channel 114. The TPA component 120 mounted in place will press the locking walls 1142 of the terminal channel 114 on both its upper and lower sides, thereby causing the locking walls 1142 of the terminal channel 114 to deform toward the inside of the terminal channels, and the latching protrusion 1146 disposed on the inner side of the locking walls 1142 (on the side toward the terminal) will sufficiently enter into the latching notch of the terminals 800 after deformation of the locking walls 1142, with the effect of preventing accidental withdrawal of the terminals 800.

FIG. 1E shows a cross-sectional view of the male connector 10 shown in FIG. 1D and another mating female connector 70 when they are in a mated state. Wherein the inner housing 110 is mounted in the outer housing 130 and a male terminal 800 is loaded into the inner housing 110, constituting a male connector 10, and the inner housing 710 is mounted in the outer housing 730 and a female terminal 900 is loaded into the inner housing 710, constituting a female connector 70 in a form of a plug. This figure enables a better understanding of the position relationship of the inner housing, terminals, TPA device and other components in the final state of use. The mounted male and female terminals in FIG. 1E may be, for example, APEX terminals which can be commercially ordered from APTIV PLC.

In the solution shown in FIGS. 1A-1D above, the TPA device 120 needs to be installed into the inner housing 110 of the male electric connector at the customer end (e.g., in an assembly plant of an OEM), which requires the use of a specialized installation tool due to the small shape of the TPA device 120 and the deep installation location. This would result in a bad experience of use at the customer end. In addition, as shown in FIG. 1E, the TPA device 120 only achieves terminal position assurance for the male terminal 800 in the male connector 10, while the female terminal 900 in the mating female connector 70 requires an additional TPA device to get locked.

### SUMMARY

In some aspects, the techniques described herein relate to a terminal position assurance device, including: one or more terminal position assurance (TPA) components, wherein each TPA component includes a male terminal lock structure on one side and a female terminal lock structure on another side.

In some aspects, the techniques described herein relate to an electric connector, including: a first connector housing, including a plurality of first terminal channels; and a terminal position assurance device, including one or more terminal position assurance (TPA) components, wherein each TPA component includes a male terminal lock structure on one side and a female terminal lock structure on another side and wherein the terminal position assurance device is capable of being installed in a terminal position assurance cavity of the first connector housing.

In some aspects, the techniques described herein relate to an electric connector assembly, including: a first electric connector including a first connector housing, wherein the first connector housing has a plurality of first terminal channels, wherein the first electric connector further includes a terminal position assurance device, wherein the terminal position assurance device includes one or more terminal position assurance (TPA) components, wherein each TPA component includes a first terminal lock structure on one side and a second terminal lock structure on another side, and wherein the terminal position assurance device is capable of being installed in a terminal position assurance cavity of the first connector housing, thereby pressing a locking wall of the first terminal channel by the first terminal lock structure; and a mating second electric connector including a second connector housing, wherein the second connector housing has a plurality of second terminal channels, wherein the second connector housing is capable of be mated and connected with the first connector housing, and wherein the terminal position assurance device presses a locking wall of the second terminal channel by means of a second terminal locking structure when the first connector housing and the second connector housing are mated and connected.

### BRIEF DESCRIPTION OF THE DRAWINGS

The present invention is now described, by way of example with reference to the accompanying drawings, in which:

FIGS. 1A and 1B show isometric views of an inner housing in a commercially delivered male electric connector according to the prior art. FIG. 1A shows a mating end of the inner housing and FIG. 1B shows a cable inlet tail of the inner housing.

FIG. 1C shows an isometric view of a single TPA device according to the prior art.

FIG. 1D shows a cross-section view of a male connector consisting of an inner housing and a corresponding outer housing according to the prior art.

FIG. 1E shows a cross-section view of the male connector shown in FIG. 1D and another mating female connector when they are in a mated state according to the prior art.

FIG. 2 shows an isometric view of an integrated terminal position assurance device and an inner housing used in conjunction therewith according to some embodiments.

FIGS. 3A, 3B, and 3C are isometric views of the integrated terminal position assurance device from different perspectives according to some embodiments.

FIG. 4 shows a cross-section view of a receptacle connector including a male inner housing and a male outer housing according to some embodiments.

FIG. 5 shows a cross-section view of the male connector shown in FIG. 4 and another corresponding female connector when they are in a mated state according to some embodiments.

### DETAILED DESCRIPTION

In the following description, the present patent application will be described with reference to various embodiments. However, those skilled in the art will recognize that various embodiments may be implemented without one or more specific details or with other alternative and/or additional methods, materials, or components. In other cases, well-known structures, materials, or operations are not shown or described in detail to avoid obscuring aspects of various embodiments of the present patent application. Similarly, for the purpose of explanation, specific quantities, materials, and configurations are set forth in order to provide a full understanding of embodiments of the present patent application. However, the present patent application may be implemented without specific details. In addition, it should be understood that various embodiments illustrated in the accompanying drawings are illustrative representations and are not necessarily drawn to scale.

Various embodiments and variations of the present patent application are further described below in conjunction with the drawings.

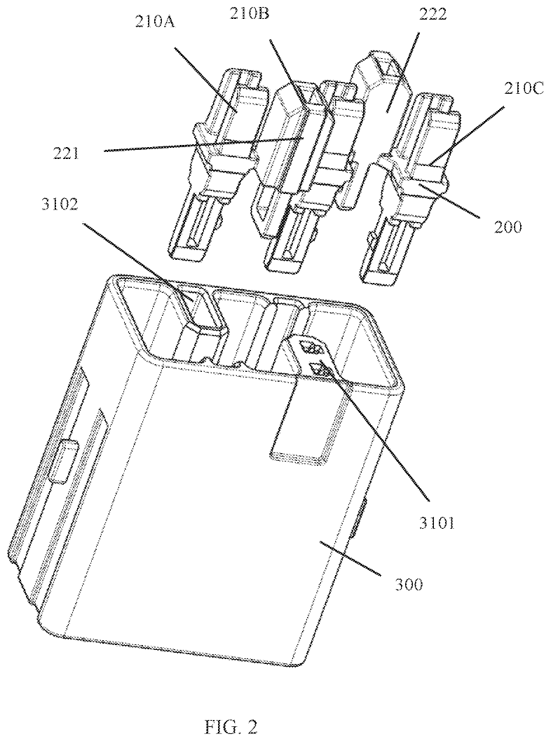

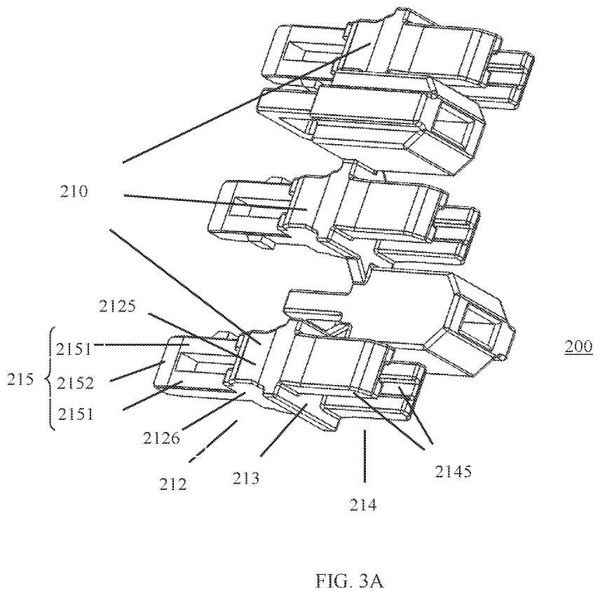

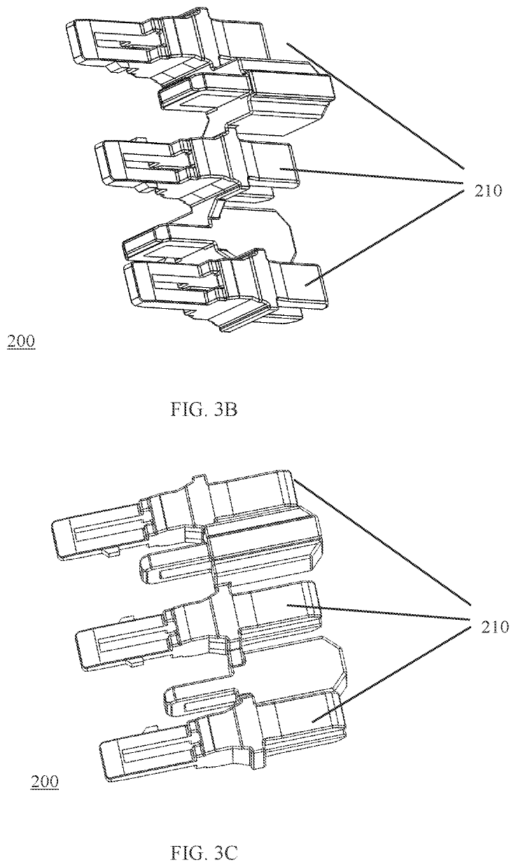

FIG. 2 is an integrated terminal position assurance device 200 and an inner housing 300 used in conjunction therewith, according to an embodiment of the present application. FIGS. 3A, 3B, and 3C are perspective views of the integrated terminal position assurance device 200 from different perspectives.

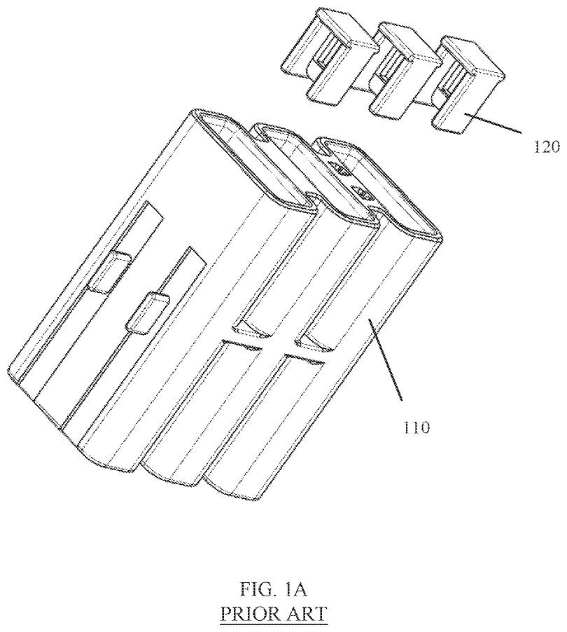

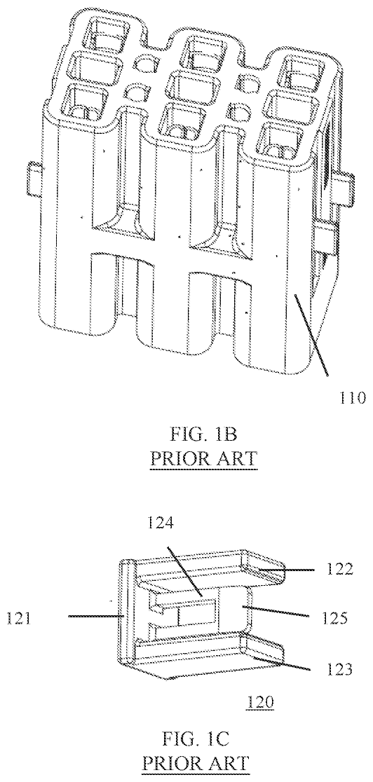

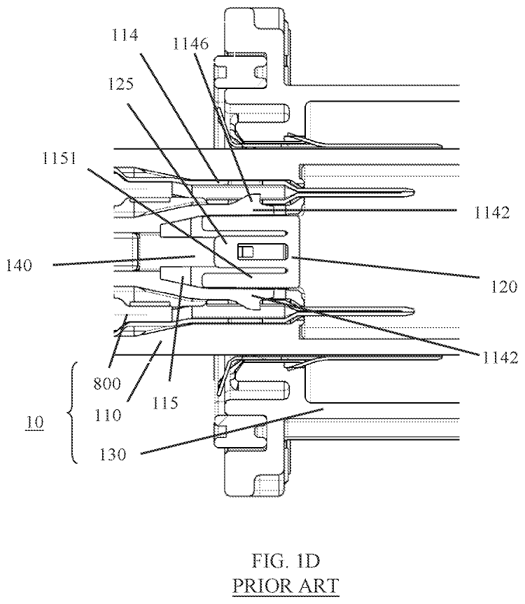

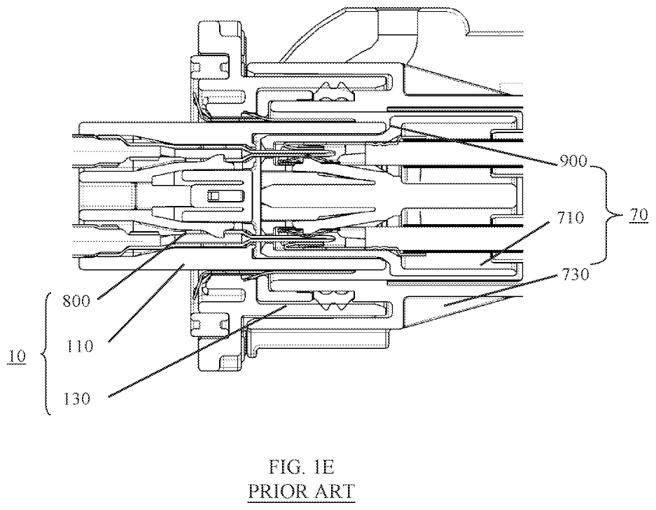

As shown in FIG. 2, similar to the connector inner housing 100 shown in FIGS. 1A and 1B, the connector inner housing 300 is a six-position (6P) connector inner housing 300 with an upper row and a lower row, which is designed to allow a terminal positioning device to be loaded from mating side. In the embodiment, three TPA components 210A, 210B, and 210C are connected together by transverse connection parts 221 and 222, thereby constituting a single-piece terminal position assurance device 200. Thus, for the connector inner housing 300 with six positions in two rows, only one part needs to be assembled to accomplish additional locking of all terminals.

Since it is intended to lock all three columns of terminals with the single-piece terminal position assurance device 200, the front end of the connector inner housing 300 is accordingly constructed to receive the single-piece terminal position assurance device 200. Specifically, the front end of the connector inner housing 300 is constructed to receive the three TPA components 210A, 210B, and 210C, as well as the transverse connecting parts 221 and 222 therebetween, without inducing physical interference to them.

As shown in FIGS. 3A-3C, TPA components 210A, 210B, and 210C (collectively TPA component 210) each include a male terminal lock structure 212 and a female terminal lock structure 214, wherein the male terminal lock structure 212 is disposed at the front end of the TPA component 210, i.e., the end that is to be inserted towards the inner housing 300, and the female terminal lock structure 214 is disposed at the rear end of the TPA component 210, i.e., an end opposite the direction of insertion. The male terminal lock structure 212 and the female terminal lock structure 214 are connected by a middle transverse substrate 213.

The female terminal lock structure 214 includes a pair of female baffles 2145, which may be two baffles (i.e., two cantilever plates) that extend from the transverse substrate 213 and being separate from each other. An opening is formed between the two female baffles 2145. This opening design helps to achieve positioning of the female baffles 2145 in the corresponding connector inner housing. When the female terminal lock structure 214 of the TPA component 210 is in a terminal locking position, the two female baffles 2145 press the walls of the female terminal channel on both sides.

The male terminal lock structure 212 includes a pair of male baffles 2125 which extend from the transverse substrate 213 and can be connected with the side baffles 2126 at upper and lower side thereof. This is conducive to enhancing its mechanical strength and thus its terminal locking force. When the male terminal lock structure 212 of the TPA component 210 is in a terminal locking position, the two male baffles 2125 press the walls of the male terminal channel on both sides.

The male terminal lock structure 212 may further include a positioning arm 215 extending toward the front end. The positioning arm 215 includes two forwardly extending axial beams 2151, and a locking crossbeam 2152 located at the end of the axial beams and connecting the two axial beams. With the help of the positioning arm 215, the mounting positioning of the TPA component 210 in the male inner housing 300 can be achieved.

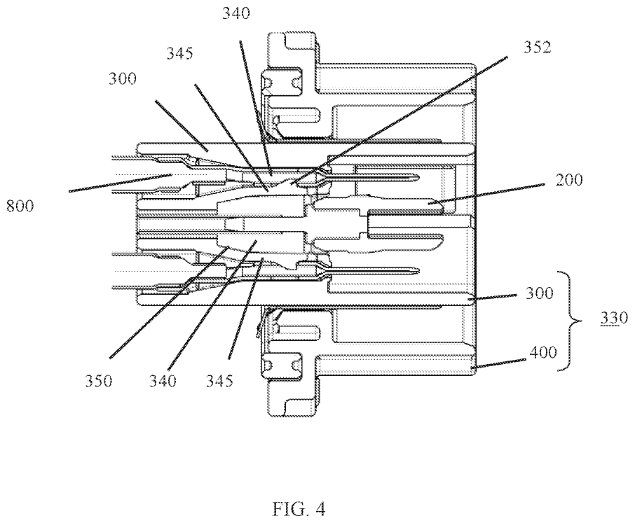

FIG. 4 shows a cross-sectional view of a receptacle connector 30 including a male inner housing 300 and a male outer housing 330, wherein a terminal position assurance device 200 as shown in FIG. 3A has been disposed in a TPA containing cavity 350 of the male inner housing 300, and whereby a portion of a side wall 445 of the TPA containing cavity 350 (the upper sidewall and the lower sidewall in FIG. 4) constitutes a locking wall of the terminal channel 340. Male baffles 2125 of the TPA component 210 mounted in place will press the locking wall 345 of the terminal channel on both the upper and lower sides, thereby causing the locking wall 345 of the terminal channel to deform toward the inside of the terminal channel, and the latching protrusion 352 disposed on the inner side of the locking wall 345 (on the side toward the terminal channel) will sufficiently enter into the latching notch of the male terminal 800 after deformation of the locking wall 345, with the effect of preventing accidental withdrawal of the male terminal 800.

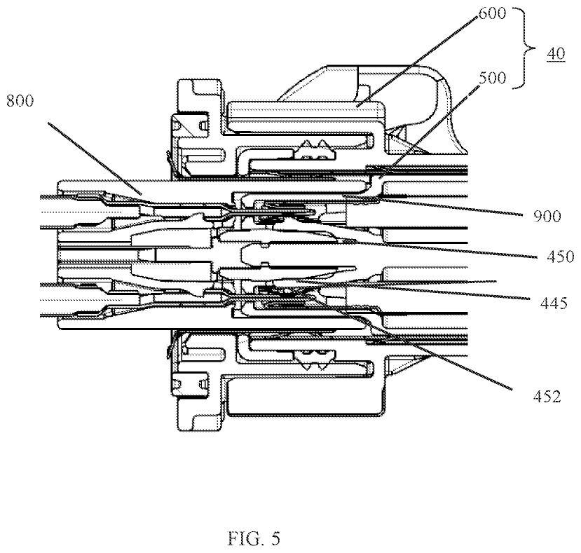

FIG. 5 shows a cross-sectional view of the male connector 30 shown in FIG. 4 and another corresponding female connector 40 when they are in a mated state. As shown in FIG. 5, the female connector 40 includes a female inner housing 500 and a female outer housing 600 assembled together, with female terminals 900 being disposed in terminal channels of the female inner housing 500. The female outer housing 600 is capable of forming a mating connection relationship with the male outer housing 400. The female inner housing 500 is also capable of forming a mating connection relationship with the male inner housing 300, wherein the front-end cavity of the female inner housing 400 is received by the front-end cavity of the male inner housing 300 so that the terminal apertures at the front of them are aligned. Pins of the male terminal 800 pass through the front terminal apertures of the male inner housing 300 and through the front terminal apertures of the female inner housing 400 so as to enter and be gripped by the terminal acceptance frame of the female terminal 900. A TPA containing cavity 450 is provided in the middle of the female inner housing 400, and female baffles of the TPA component 210 press on a side wall 445 of the TPA containing cavity 450 (which forms a portion of a terminal channel), thereby causing the side wall 445 to deform inwardly toward the terminal channel, and a latching protrusion 452 disposed on the inner side of the side wall 445 (on the side facing the terminal channel) sufficiently enters into a latching notch of the female terminal 900 after the deformation of the side wall 445, which has the effect of preventing the accidental withdrawal of the female terminal 900.

Accordingly, with the use of the TPA component 210 having both a male terminal lock structure and a female terminal lock structure, the need to develop, produce, and assemble separate TPA devices for the male inner housing 300 and the female inner housing 500 is eliminated.

In addition, optionally, by connecting a plurality of TPA components 210 with a transverse connecting part so as to constitute a single-piece terminal position assurance device 200 including the plurality of TPA components 210, both the manufacturing cost and the assembly cost are further reduced.

Transverse connecting parts 221 and 222 may be simple connection crossbeam structure or be a connection block structure that better conforms with the inner wall of the inner housing 300 to enhance the structural strength and mounting stability of the single-piece terminal position assurance device 200. For example, as shown in FIG. 2, since the inner housing 300 is provided with a high-voltage interlocking (HVIL) cavity 3101 of HVIL terminals, the height of which occupies about half of the overall height of the inner housing 300, the transverse connection part 222 is designed to be a connection block that has a width matching the width of the HVIL cavity 3101 and a height occupying the other half of the height of the inner housing 300. The inner housing 300 is further provided with an idle cavity 3102 that is symmetrical to the HVIL cavity, and the transverse connection part 221 thus has a similar symmetrical design.

In the foregoing embodiments, a single-piece terminal position assurance device 200 including three TPA components 210 is illustrated, but it is to be understood that the number of TPA components 210 is not to be limited in the present application. Accordingly, the terminal position assurance device of the present application shall cover implementations in which there is only one integrated TPA component 210 and hence no transverse connection part is required.

In the foregoing embodiments, a positioning arm 215 is provided at the end of the male terminal lock structure 212, so that the TPA component 210 is to be loaded into the male inner housing, and then with the aid of the engagement of the male inner housing and the female inner housing, the female terminal lock structure of the TPA component 210 enters into a terminal locking position. In other implementations, a positioning arm 215 of suitable form may be provided at the end of the female terminal lock structure 214, so that the TPA component is to be loaded into the female inner housing, and then with the aid of the engagement of the female inner housing and the male inner housing, the male terminal lock structure of the TPA component enters a terminal locking position.

In the present application, the specific constructions of the male inner housing and the female inner housing are only examples. It is to be understood that the present application shall cover combinations of male and female inner housings of various types, wherein the integrated terminal position assurance device is adapted to be mounted into one of the male and female inner housings, and wherein a pressing action is to be applied to the walls of the terminal channels in both the male and female inner housings to lock the terminals when the male and female inner housings are mated in place.

In the present application, the specific constructions of the male outer housing and the female outer housing are only examples as well. In possible embodiments, only one connector housing is provided, and it is not divided into an outer housing and an inner housing.

In the present application, one TPA component is used to press two terminal channels, and it is to be understood that the number of terminal channels may be one, or some other number, as long as they are capable of being pressed simultaneously by a single TPA component.

It should also be understood that, in the drawings of this application, some of the structures on the TPA component 210 are to meet a particular requirement of product development design, but are not yet directly related to the claimed idea of the invention, and the fact that these structures are graphically or literally represented in the present application does not mean that these structures are essential features for implementing the invention.

### Discussion of Possible Embodiments

The following are non-exclusive descriptions of possible embodiments of the present invention.

In some aspects, the techniques described herein relate to a terminal position assurance device, including: one or more terminal position assurance (TPA) components, wherein each TPA component includes a male terminal lock structure on one side and a female terminal lock structure on another side.

In some aspects, the techniques described herein relate to a terminal position assurance device, wherein the TPA component includes a transverse substrate, wherein the male terminal lock structure and the female terminal lock structure extend from each end of the transverse substrate.

In some aspects, the techniques described herein relate to a terminal position assurance device, wherein the TPA component further includes a positioning arm extending from the male terminal lock structure or the female terminal lock structure.

In some aspects, the techniques described herein relate to a terminal position assurance device, wherein the positioning arm includes two forwardly extending axial beams and a locking crossbeam located at an end of the axial beams and connecting the axial beams.

In some aspects, the techniques described herein relate to a terminal position assurance device, wherein the male terminal lock structure includes a male baffle and wherein the female terminal lock structure includes a female baffle.

In some aspects, the techniques described herein relate to a terminal position assurance device, including two or more of the TPA component and wherein the terminal position assurance device further includes a transverse connection part connecting respective TPA components.

In some aspects, the techniques described herein relate to an electric connector, including: a first connector housing, including a plurality of first terminal channels; and a terminal position assurance device, including one or more terminal position assurance (TPA) components, wherein each TPA component includes a male terminal lock structure on one side and a female terminal lock structure on another side and wherein the terminal position assurance device is capable of being installed in a terminal position assurance cavity of the first connector housing.

In some aspects, the techniques described herein relate to an electric connector, wherein the terminal position assurance cavity has an opening facing a mating end of the first connector housing.

In some aspects, the techniques described herein relate to an electric connector, wherein the first connector housing is a male connector housing for receiving a male terminal and wherein the male terminal lock structure of the terminal position assurance device is capable of being installed in the terminal position assurance cavity of the male connector housing.

In some aspects, the techniques described herein relate to an electric connector, wherein the male terminal lock structure includes a male baffle, wherein the male baffle is configured to press a side wall of an adjacent terminal position assurance cavity, wherein the side wall to be pressed forms a locking wall of the first terminal channel, and wherein a latching protrusion is provided on a side of the locking wall facing an interior of the first terminal channel.

In some aspects, the techniques described herein relate to an electric connector, wherein the TPA components further include a positioning arm extending from the male terminal lock structure and wherein the positioning arm is to position the terminal position assurance device in the terminal position assurance cavity of the male connector housing.

In some aspects, the techniques described herein relate to an electric connector, wherein the female terminal lock structure includes a female baffle.

In some aspects, the techniques described herein relate to an electric connector, wherein the terminal channels of the first connector housing are arranged in two rows and multiple columns and wherein each TPA component is to be installed between the terminal channels of a corresponding column.

In some aspects, the techniques described herein relate to an electric connector, wherein the first connector housing includes two or more columns of terminal channels, wherein the electric connector correspondingly includes two or more of the TPA components, and wherein the two or more TPA components are integrally connected to each other by means of a transverse connection part.

In some aspects, the techniques described herein relate to an electric connector, wherein the transverse connection part is a connection crossbeam structure.

In some aspects, the techniques described herein relate to an electric connector, wherein the transverse connection part includes a connection block structure.

In some aspects, the techniques described herein relate to an electric connector, wherein the first connector housing includes a high-voltage interlocking (HVIL) cavity between two adjacent columns of terminal channels and wherein the connection block structure has a width matching the width of the HVIL cavity.

In some aspects, the techniques described herein relate to an electric connector, wherein the first connector housing is an inner housing.

In some aspects, the techniques described herein relate to an electric connector assembly, including: a first electric connector including a first connector housing, wherein the first connector housing has a plurality of first terminal channels, wherein the first electric connector further includes a terminal position assurance device, wherein the terminal position assurance device includes one or more terminal position assurance (TPA) components, wherein each TPA component includes a first terminal lock structure on one side and a second terminal lock structure on another side, and wherein the terminal position assurance device is capable of being installed in a terminal position assurance cavity of the first connector housing, thereby pressing a locking wall of the first terminal channel by the first terminal lock structure; and a mating second electric connector including a second connector housing, wherein the second connector housing has a plurality of second terminal channels, wherein the second connector housing is capable of be mated and connected with the first connector housing, and wherein the terminal position assurance device presses a locking wall of the second terminal channel by means of a second terminal locking structure when the first connector housing and the second connector housing are mated and connected.

In some aspects, the techniques described herein relate to an electric connector assembly, wherein the first electric connector is a male connector, within the first connector housing is a male inner housing, wherein the second electric connector is a female connector, and wherein the second connector housing is a female inner housing.

The present application utilizes specific phraseology to describe embodiments thereof. For example, “one embodiment”, “an embodiment”, and/or “some embodiments” means a feature, structure, or characteristic associated with at least one embodiment of the present application. Accordingly, it should be emphasized and noted that “an embodiment” or “one embodiment” or “an alternative embodiment” mentioned two or more times in different places in the description do not necessarily refer to the same embodiment. Furthermore, certain features, structures, or characteristics of one or more embodiments of the present application may be appropriately combined.

In the context of the present application, the words “a”, “an” and/or “the” and the like do not necessarily refer to the singular, but may also include the plural, unless the context clearly dictates otherwise. Generally, the terms “including” and “comprising” suggest only the inclusion of clearly identified steps and elements, which do not constitute an exclusive list, and the method or apparatus may also contain other steps or elements.

Similarly, it should be noted that in order to simplify the presentation of the disclosure of the present application, and thereby aid in the understanding of one or more embodiments of the invention, the foregoing descriptions of the embodiments of the present application sometimes combine a variety of features into a single embodiment, figure, or the description thereof. However, such a method of disclosure does not imply that the subject of the present application requires more features than those mentioned in the claims. In fact, embodiments are to have fewer features than all features of a foregoing disclosed single embodiment.

The basic concepts have been described above, and it will be apparent to those skilled in the art that the foregoing disclosure is intended to be exemplary only and does not constitute a limitation of the present application. Although not expressly stated herein, those skilled in the art may make various modifications, improvements, and amendments to this application. Such modifications, improvements, and amendments are suggested in this application, so such modifications, improvements, and amendments remain within the spirit and scope of the embodiments of this application.

1. A terminal position assurance device, comprising:
one or more terminal position assurance (TPA) components, wherein each TPA component comprises a male terminal lock structure on one side and a female terminal lock structure on another side.

2. The terminal position assurance device of claim 1, wherein the TPA component comprises a transverse substrate, wherein the male terminal lock structure and the female terminal lock structure extend from each end of the transverse substrate.

3. The terminal position assurance device of claim 1, wherein the TPA component further comprises a positioning arm extending from the male terminal lock structure or the female terminal lock structure.

4. The terminal position assurance device of claim 3, wherein the positioning arm comprises two forwardly extending axial beams and a locking crossbeam located at an end of the axial beams and connecting the axial beams.

5. The terminal position assurance device of claim 1, wherein the male terminal lock structure comprises a male baffle and wherein the female terminal lock structure comprises a female baffle.

6. The terminal position assurance device of claim 1, comprising two or more of the TPA component and wherein the terminal position assurance device further comprises a transverse connection part connecting respective TPA components.

7. An electric connector, comprising:
a first connector housing, comprising a plurality of first terminal channels; and
a terminal position assurance device, comprising one or more terminal position assurance (TPA) components, wherein each TPA component comprises a male terminal lock structure on one side and a female terminal lock structure on another side and wherein the terminal position assurance device is capable of being installed in a terminal position assurance cavity of the first connector housing.

8. The electric connector of claim 7, wherein the terminal position assurance cavity has an opening facing a mating end of the first connector housing.

9. The electric connector of claim 7, wherein the first connector housing is a male connector housing for receiving a male terminal and wherein the male terminal lock structure of the terminal position assurance device is capable of being installed in the terminal position assurance cavity of the male connector housing.

10. The electric connector of claim 9, wherein the male terminal lock structure comprises a male baffle, wherein the male baffle is configured to press a side wall of an adjacent terminal position assurance cavity, wherein the side wall to be pressed forms a locking wall of the first terminal channel, and wherein a latching protrusion is provided on a side of the locking wall facing an interior of the first terminal channel.

11. The electric connector of claim 9, wherein the TPA components further comprise a positioning arm extending from the male terminal lock structure and wherein the positioning arm is to position the terminal position assurance device in the terminal position assurance cavity of the male connector housing.

12. The electric connector of claim 9, wherein the female terminal lock structure comprises a female baffle.

13. The electric connector of claim 7, wherein the terminal channels of the first connector housing are arranged in two rows and multiple columns and wherein each TPA component is to be installed between the terminal channels of a corresponding column.

14. The electric connector of claim 9, wherein the first connector housing comprises two or more columns of terminal channels, wherein the electric connector correspondingly comprises two or more of the TPA components, and wherein the two or more TPA components are integrally connected to each other by means of a transverse connection part.

15. The electric connector of claim 14, wherein the transverse connection part is a connection crossbeam structure.

16. The electric connector of claim 14, wherein the transverse connection part comprises a connection block structure.

17. The electric connector of claim 16, wherein the first connector housing comprises a high-voltage interlocking (HVIL) cavity between two adjacent columns of terminal channels and wherein the connection block structure has a width matching the width of the HVIL cavity.

18. The electric connector of claim 16, wherein the first connector housing is an inner housing.

19. An electric connector assembly, comprising:
a first electric connector comprising a first connector housing, wherein the first connector housing has a plurality of first terminal channels, wherein the first electric connector further comprises a terminal position assurance device, wherein the terminal position assurance device comprises one or more terminal position assurance (TPA) components, wherein each TPA component comprises a first terminal lock structure on one side and a second terminal lock structure on another side, and wherein the terminal position assurance device is capable of being installed in a terminal position assurance cavity of the first connector housing, thereby pressing a locking wall of the first terminal channel by the first terminal lock structure; and
a mating second electric connector comprising a second connector housing, wherein the second connector housing has a plurality of second terminal channels, wherein the second connector housing is capable of be mated and connected with the first connector housing, and wherein the terminal position assurance device presses a locking wall of the second terminal channel by means of a second terminal locking structure when the first connector housing and the second connector housing are mated and connected.

20. The electric connector assembly of claim 19, wherein the first electric connector is a male connector, within the first connector housing is a male inner housing, wherein the second electric connector is a female connector, and wherein the second connector housing is a female inner housing.
